(19) United States
(12) Patent Application Publication
(10) Pub. No.: US 2022/0101155 A1
(43) Pub. Date: Mar. 31, 2022

(54) Trajectory Generation Using Road Network Model

(71) Applicant: Motional AD LLC, Boston, MA (US)

(72) Inventors: Robert Beaudoin, Somerville, MA (US); Eric Wolff, Boston, MA (US)

(21) Appl. No.: 17/033,615

(22) Filed: Sep. 25, 2020

(51) Int. Cl. G06N 5/04; G08G 1/056; G06N 20/00

(52) U.S. Cl. CPC G06N 5/04; G06N 20/00; G08G 1/056

(57) ABSTRACT

Enclosed are embodiments for trajectory generation using a road network model. In an embodiment, a method includes: obtaining, using at least one processor of a vehicle, a location of the vehicle; obtaining, using the at least one processor, sensor data collected at the location; obtaining, using the at least one processor, map data for the location; generating, using the one or more processors, at least on possible trajectory for at least one object at the location, wherein the possible trajectory is constrained in accordance with the map data; and predicting, using a machine learning model, a score for the at least one trajectory.

### FIELD OF THE INVENTION

The description that follows relates generally to training machine learning models for motion prediction.

### BACKGROUND

For safe and reliable autonomous vehicles, the prediction of trajectories of surrounding agents (e.g., vehicles, pedestrians, bicyclists) in a traffic scenario is critical. Most approaches rely on data gathered by a sensor suite (e.g., cameras, radar, LiDAR, etc.) carried on the autonomous vehicle, and some approaches combine the sensor data with road map data, to predict the trajectories of the surrounding agents. In many cases, sensor data is processed by machine learning methods from computer vision, producing as intermediate results (before the final trajectory predictions) either a feature vector encoding the entire observed scene, or a feature map or both.

Some approaches attempt to model a restricted number of intentions for agents (other than the AV) in the scene, and condition their trajectory predictions on those intentions. Other approaches focus on modeling the interactions between agents and how those interactions will impact future trajectories. Still other approaches translate map data into a topological graph and encode it along with trajectory histories into feature vectors processed with a graph neural network, which generates the trajectory predictions.

The approaches described above use road map data implicitly by providing the road map data as one input to a neural network, which in turn outputs trajectory predictions. The use of road map data in this manner, however, may result in agent trajectories that do not satisfy constraints imposed by the road map data, and/or do not include all possible behaviors or intentions of each agent whose trajectory is being predicted.

### SUMMARY

Techniques are provided for trajectory generation using a road network model.

In an embodiment, a method comprises: obtaining, using at least one processor, scene data, the scene data including a current location of a vehicle, sensor data captured at the location and road map data for the location; generating, using the at least one processor, at least one possible trajectory template for at least one agent at the location based on the scene data, wherein the at least one possible trajectory template is constrained in accordance with the road map data; and predicting, using the at least one processor, a score for the at least one possible trajectory template using a machine learning model.

In an embodiment, the method further comprises constraining the trajectory template to a particular lane or connector in the road map data.

In an embodiment, predicting, using a machine learning model, a score for the at least one possible trajectory template further comprises: generating, an image embedding of the sensor data and the road map data; processing, using a convolution neural network, the image embedding to provide a feature map and a global feature vector; generating, using the at least one processor, a local feature vector by combining the feature map with the at least one trajectory template using a spatial attention mechanism; generating, using the at least one processor, input data by combining the template trajectory position coordinates, the local feature vector, the global feature vector and an agent state vector; inputting, into the machine learning model, the input data; and predicting, using the machine learning model, the score for the at least one possible trajectory template.

In an embodiment, the feature map is an image with one feature vector per pixel encoding spatial variation in the sensor data.

In an embodiment, the global feature vector summarizes the sensor data for the location.

In an embodiment, the method further comprises: providing the input data to a refinement model that outputs adjustments to the at least one trajectory template.

In an embodiment, the adjustments include increasing or decreasing a speed of one or more agents at the location.

In an embodiment, the adjustments include laterally displacing one or more agents from a centerline of a road at the location.

In an embodiment, the sensor data includes at least one of a camera image or a point cloud from a light detection and ranging (LiDAR) sensor captured at the location.

In an embodiment, the sensor data includes data output by a perception module of the vehicle.

In an embodiment, the at least one agent includes at least one pedestrian and the road map data includes walkway or crosswalk data.

In an embodiment, there are two or more agents and trajectories are generated in parallel based on shared data.

In an embodiment, the at least one trajectory template includes all possible intended behavior of the at least one agent based on the road map data.

In an embodiment, generating, using the at least one processor, the at least one trajectory template for the at least one agent, further comprises: searching the road map data for lanes and connectors of a road network that are within a fixed radius of the location; discretizing each lane or connector found in the search using a default spacing; and for each lane and connector, drawing a path for the at least one agent that begins from a start pose of the at least one agent, merges into the lane or connector and then follows the lane or connector.

In an embodiment, the at least one trajectory template is drawn using Dubins curves.

In an embodiment, a system comprises: at least one processor; memory storing instructions that when executed by the at least one processor, cause the at least one processor to perform any of the methods described above.

In an embodiment, a non-transient, computer-readable storage medium having stored thereon instructions, that when execute by at least one processor, cause the at least one processor any of the methods previously described.

One or more of the disclosed embodiments provide one or more of the following advantages. Trajectory templates for each agent in a scene (determined by the location of an AV and its sensor data) are generated using road map data. The trajectory templates are used, for example, to train a deep learning model for motion prediction. The road map data ensures that each trajectory template for each agent in the scene ends in all reasonable lanes, including but not limited to: trajectories for left/right turns, U-turns and lane changes, etc. Also, the road map data and physical constraints of the agents (e.g., turning radius, speed, acceleration) are used to ensure that all generated trajectory templates are dynamically feasible (i.e., the trajectories satisfy constraints imposed by the road map data). The use of road map data also ensures that the trajectory templates include each possible intended behavior of the agent, based on the road map geometry. For example, when approaching a “T” intersection from the stem of the “T,” generate a left turn, a right turn, and depending on the speed of the vehicle, a “U” turn. But if the street at the top of the “T” is one-way, generate only the appropriate turn. When between intersections on a three lane one-way street, generate three trajectories: two lane changes and one that stays in lane.

Some advantages over existing methods is that the road map data provides prior information about the likely behavior of other agents in a scene (e.g., vehicles tend to stay on the road and drive in accord with lane locations and directions). These priors can enable more accurate predictive models (e.g., more accurate motion prediction models). Also, higher accuracy can be achieved with simpler deep learning models (e.g., simpler and thus faster neural networks).

Other advantages over other existing approaches is that use of road map data improves interpretability and control over the deep learning models. Deep learning models (e.g., deep neural networks) in practice are opaque (if not black) boxes that generate trajectories as deep network outputs which are difficult in practice to understand or control gross properties of the predicted paths. By using road map data in trajectory generation, and training the deep learning model on the predicted trajectories the predictions output by the deep learning model can be better interpreted, i.e., tied back to particular road map constraints and types of trajectories, allowing for improved fine tuning of the deep learning models.

Still other advantages are improved efficiency. For example, when predicting for multiple possible trajectory templates for a particular agent, or multiple agents in the same scene, scene data (e.g., AV current location, AV sensor data) can be processed once and reused, resulting in a model that operates faster than models that require scene data to be regenerated for each agent trajectory. Also, the explicit generation of trajectory templates prevents possibility of mode collapse.

For example, trajectory prediction models are often divided into those that are “unimodal,” meaning they predict a single most-likely trajectory, or “mode,” and those that are “multimodeal,” which predict several likely trajectories, or “modes,” along with estimated probabilities for each. But sometimes putatively multimodal models will have output in which most or all of the modes are identical of nearly so, effectively making the prediction unimodal. This is called mode collapse. Except in very simple situations (e.g., a car moving fast down a one-lane one-way street nowhere near an intersection) the disclosed embodiments ensure that several distinct trajectory proposals are created, precluding mode collapse.

These and other aspects, features, and implementations can be expressed as methods, apparatus, systems, components, program products, means or steps for performing a function, and in other ways. These and other aspects, features, and implementations will become apparent from the following descriptions, including the claims.

### BRIEF DESCRIPTION OF THE DRAWINGS

FIG. 1 shows an example of an autonomous vehicle (AV) having autonomous capability, in accordance with one or more embodiments.

FIG. 2 illustrates an example “cloud” computing environment, in accordance with one or more embodiments.

FIG. 3 illustrates a computer system, in accordance with one or more embodiments.

FIG. 4 shows an example architecture for an AV, in accordance with one or more embodiments.

FIGS. 5A-5C illustrate example trajectory templates for a vehicle for various example traffic scenarios, in accordance with one or more embodiments.

FIG. 6 is a block diagram of a trajectory template generation system for generating trajectory templates for agent(s) in a scene, in accordance with one or more embodiments.

FIG. 7 is a flow diagram of a process for generating trajectory templates for training a deep learning model, in accordance with one or more embodiments.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

In the drawings, specific arrangements or orderings of schematic elements, such as those representing devices, modules, instruction blocks and data elements, are shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some embodiments.

Further, in the drawings, where connecting elements, such as solid or dashed lines or arrows, are used to illustrate a connection, relationship, or association between or among two or more other schematic elements, the absence of any such connecting elements is not meant to imply that no connection, relationship, or association can exist. In other words, some connections, relationships, or associations between elements are not shown in the drawings so as not to obscure the disclosure. In addition, for ease of illustration, a single connecting element is used to represent multiple connections, relationships or associations between elements. For example, where a connecting element represents a communication of signals, data, or instructions, it should be understood by those skilled in the art that such element represents one or multiple signal paths (e.g., a bus), as may be needed, to affect the communication.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Several features are described hereafter that can each be used independently of one another or with any combination of other features. However, any individual feature may not address any of the problems discussed above or might only address one of the problems discussed above. Some of the problems discussed above might not be fully addressed by any of the features described herein. Although headings are provided, information related to a particular heading, but not found in the section having that heading, may also be found elsewhere in this description. Embodiments are described herein according to the following outline:

1. General Overview

2. System Overview

3. Autonomous Vehicle Architecture

4. Trajectory Generation Using Road Network Model

### General Overview

Techniques are provided for improving predictions of trajectories of agents (e.g., vehicles, pedestrians, bicyclists) in the vicinity of an AV. Road map data is input into a trajectory template generation system used to generate trajectory templates or “hypotheses” for a particular traffic scenario. The trajectory generation system takes into account lane geometry in the road map data and applicable geometric and physical constraints on the behavior of vehicles and other agents to generate a set of trajectory templates for the traffic scenario.

The set of trajectory templates are feasible, in that they satisfy constraints imposed by the road map data, and exhaustive in that they include all possible behaviors or intentions of each agent whose trajectory is being predicted. For example, in an example traffic scenario a vehicle on a two-way, two-lane road approaching a one-way cross street will have two likely trajectories: one continuing on the same road and one turning into the cross street. In another example traffic scenario, a vehicle on a two-lane one-way street between intersections will have two likely trajectories: one staying in the current lane and one changing lanes.

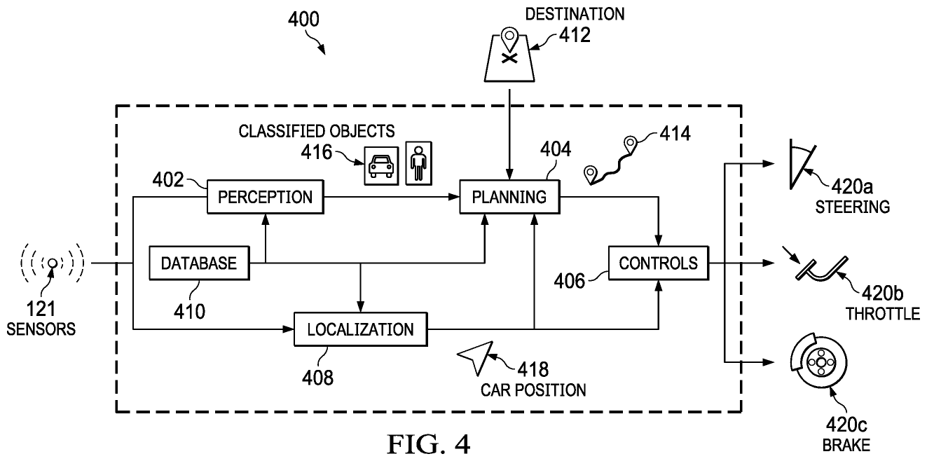

In an embodiment, the set of trajectory templates are used to train and evaluate a deep learning model for motion prediction. The trained and evaluated deep learning model can then be used by planning module 404 shown in FIG. 4, to generate routes for detected agents in various traffic scenarios, where each route has a score (e.g., a probability) that planning module 404 can use to generate and select a route for the AV to, for example, avoid a collision with an object.

### System Overview

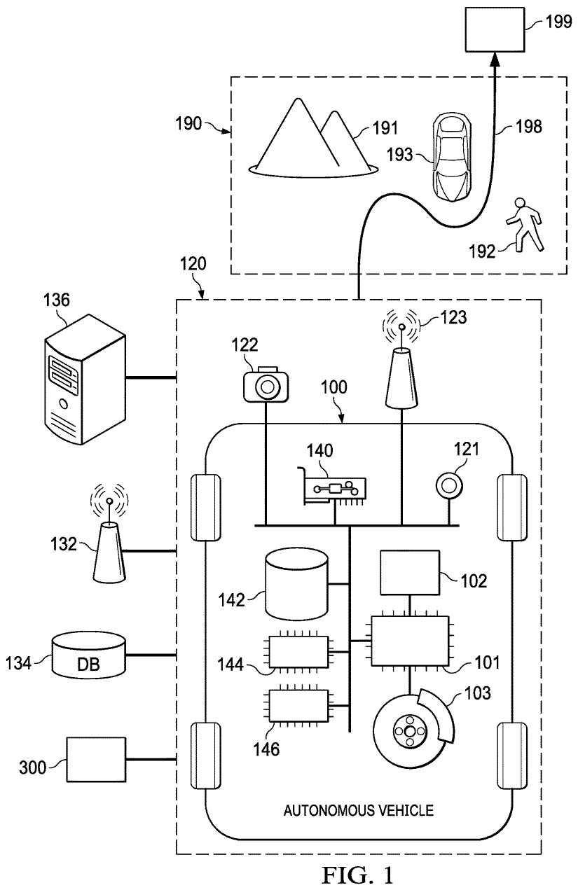

FIG. 1 shows an example of an autonomous vehicle 100 having autonomous capability.

As used herein, the term “autonomous capability” refers to a function, feature, or facility that enables a vehicle to be partially or fully operated without real-time human intervention, including without limitation fully autonomous vehicles, highly autonomous vehicles, and conditionally autonomous vehicles.

As used herein, an autonomous vehicle (AV) is a vehicle that possesses autonomous capability.

As used herein, “vehicle” includes means of transportation of goods or people. For example, cars, buses, trains, airplanes, drones, trucks, boats, ships, submersibles, dirigibles, motorcycles, bicycles, etc. A driverless car is an example of a vehicle.

As used herein, “trajectory” refers to a path or route to operate an AV from a first spatiotemporal location to second spatiotemporal location. In an embodiment, the first spatiotemporal location is referred to as the initial or starting location and the second spatiotemporal location is referred to as the destination, final location, goal, goal position, or goal location. In some examples, a trajectory is made up of one or more segments (e.g., sections of road) and each segment is made up of one or more blocks (e.g., portions of a lane or intersection). In an embodiment, the spatiotemporal locations correspond to real world locations. For example, the spatiotemporal locations are pick up or drop-off locations to pick up or drop-off persons or goods.

As used herein, “sensor(s)” includes one or more hardware components that detect information about the environment surrounding the sensor. Some of the hardware components can include sensing components (e.g., image sensors, biometric sensors), transmitting and/or receiving components (e.g., laser or radio frequency wave transmitters and receivers), electronic components such as analog-to-digital converters, a data storage device (such as a RAM and/or a nonvolatile storage), software or firmware components and data processing components such as an ASIC (application-specific integrated circuit), a microprocessor and/or a microcontroller.

As used herein, a “road” is a physical area that can be traversed by a vehicle, and may correspond to a named thoroughfare (e.g., city street, interstate freeway, etc.) or may correspond to an unnamed thoroughfare (e.g., a driveway in a house or office building, a section of a parking lot, a section of a vacant lot, a dirt path in a rural area, etc.). Because some vehicles (e.g., 4-wheel-drive pickup trucks, sport utility vehicles, etc.) are capable of traversing a variety of physical areas not specifically adapted for vehicle travel, a “road” may be a physical area not formally defined as a thoroughfare by any municipality or other governmental or administrative body.

As used herein, a “lane” is a portion of a road that can be traversed by a vehicle and may correspond to most or all of the space between lane markings, or may correspond to only some (e.g., less than 50%) of the space between lane markings. For example, a road having lane markings spaced far apart might accommodate two or more vehicles between the markings, such that one vehicle can pass the other without traversing the lane markings, and thus could be interpreted as having a lane narrower than the space between the lane markings or having two lanes between the lane markings. A lane could also be interpreted in the absence of lane markings. For example, a lane may be defined based on physical features of an environment, e.g., rocks and trees along a thoroughfare in a rural area.

As used herein, a “scene” is a particular AV location, road map data for the area surrounding the particular AV location and any agents at the particular AV location.

As used herein, “scene data” is data representing the “scene” and includes sensor data, a location of the AV (e.g., GNSS coordinates), weather conditions, road map data for the area surrounding the AV location, and any other data that is available and useful for motion prediction. Sensor data can include, for example, camera images and LiDAR point clouds. In some cases, the sensor data includes detections of other agents (e.g., other vehicles, pedestrians, bicycles). Sensor data can also include locations of stationary objects (e.g., curbs, Jersey barriers, fences, etc.)

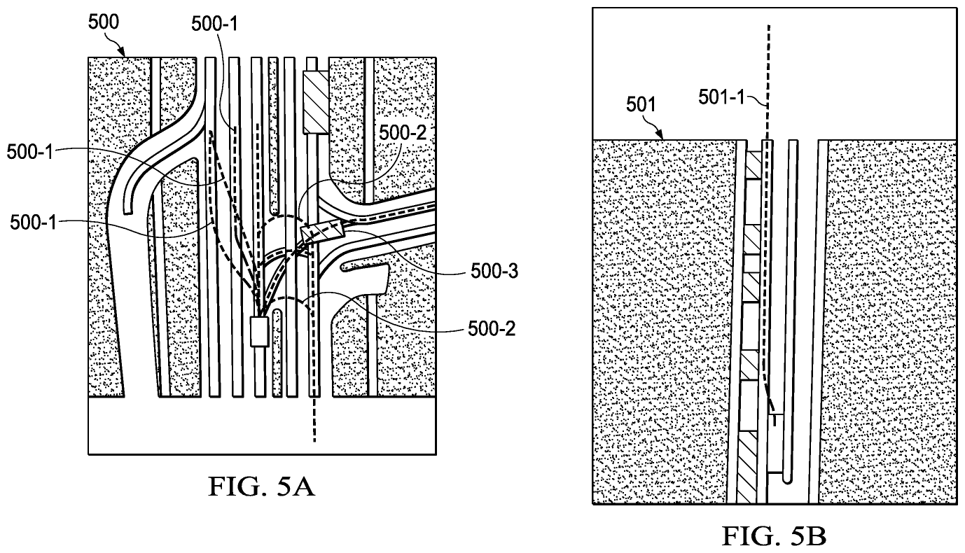

As used herein, a “feature map” is an image with one feature vector per pixel encoding spatial variation in sensor data at the current AV location. The feature map may encode more than sensor data or all or a portion of scene data. In an embodiment, an image of the scene (e.g., a “bird's eye view (BEV) image), including a rendering of driveable road areas versus non-driveable areas, lanes, past and present positions of vehicles, pedestrians, bicyclists, etc., an example of which is shown in FIG. 5A-5C as input to feature map generator xxx.

As used herein, “global feature vector” is a vector in n-dimensional space summarizing the scene data.

As used herein, an “attention mechanism” is a learned model that selects a small number of locations of the input image (e.g., a BEV image) to sample. In an embodiment, a “multi-headed” attention mechanism is used to sample or “attend” to more than one region in the input image. For example, assuming a right-hand-side driving country, the attention mechanism may learn to attend both to the lane being merged into and the lane which might contain oncoming traffic which the agent might have to cross in front of.

As used herein, “local feature vector” is a vector that is produced by the attention mechanism. The local feature vector couples a given trajectory template to the input image, so that when the trajectory and input image are input into a convolution neural network, the convolutional neural network knows which portions of the input image are relevant to the trajectory template.

For example, scene data is rasterized into an image (e.g., a bird's eye view (BEV) image), which is processed by the attention mechanism that compiles a local summary of those portions of the BEV image that are relevant to the trajectory template, and encodes the compiled local summary into a local feature vector. For example, if the trajectory template for an agent makes a left turn, then the lane that the agent merges into would be flagged by the local feature vector and used by the convolution neural network to predict a score for that template trajectory.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “includes,” and/or “including,” when used in this description, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

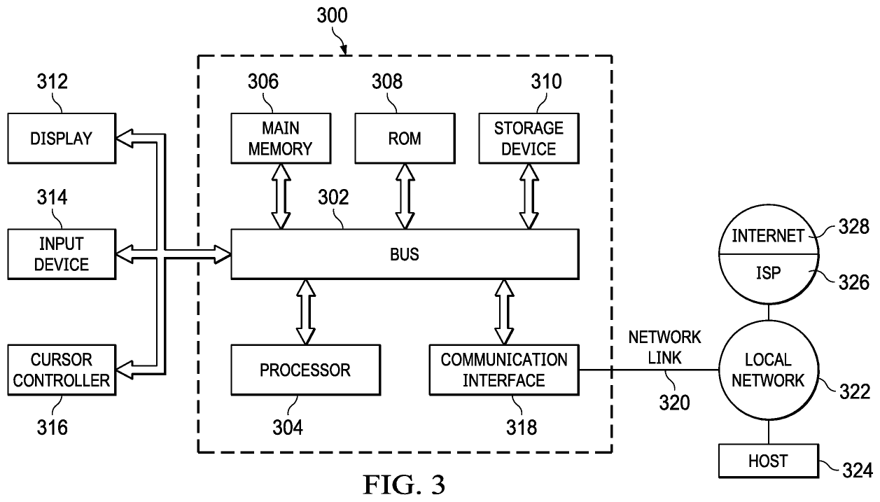

As used herein, an AV system refers to the AV along with the array of hardware, software, stored data, and data generated in real-time that supports the operation of the AV. In an embodiment, the AV system is incorporated within the AV. In an embodiment, the AV system is spread across several locations. For example, some of the software of the AV system is implemented on a cloud computing environment similar to cloud computing environment 300 described below with respect to FIG. 3.

In general, this document describes technologies applicable to any vehicles that have one or more autonomous capabilities including fully autonomous vehicles, highly autonomous vehicles, and conditionally autonomous vehicles, such as so-called Level 5, Level 4 and Level 3 vehicles, respectively (see SAE International's standard J3016: Taxonomy and Definitions for Terms Related to On-Road Motor Vehicle Automated Driving Systems, which is incorporated by reference in its entirety, for more details on the classification of levels of autonomy in vehicles). The technologies described in this document are also applicable to partially autonomous vehicles and driver assisted vehicles, such as so-called Level 2 and Level 1 vehicles (see SAE International's standard J3016: Taxonomy and Definitions for Terms Related to On-Road Motor Vehicle Automated Driving Systems). In an embodiment, one or more of the Level 1, 2, 3, 4 and 5 vehicle systems may automate certain vehicle operations (e.g., steering, braking, and using maps) under certain operating conditions based on processing of sensor inputs. The technologies described in this document can benefit vehicles in any levels, ranging from fully autonomous vehicles to human-operated vehicles.

Referring to FIG. 1, an AV system 120 operates the AV 100 along a trajectory 198 through an environment 190 to a destination 199 (sometimes referred to as a final location) while avoiding objects (e.g., natural obstructions 191, vehicles 193, pedestrians 192, cyclists, and other obstacles) and obeying rules of the road (e.g., rules of operation or driving preferences).

In an embodiment, the AV system 120 includes devices 101 that are instrumented to receive and act on operational commands from the computer processors 146. In an embodiment, computing processors 146 are similar to the processor 304 described below in reference to FIG. 3. Examples of devices 101 include a steering control 102, brakes 103, gears, accelerator pedal or other acceleration control mechanisms, windshield wipers, side-door locks, window controls, and turn-indicators.

In an embodiment, the AV system 120 includes sensors 121 for measuring or inferring properties of state or condition of the AV 100, such as the AV's position, linear velocity and acceleration, angular velocity and acceleration, and heading (e.g., an orientation of the leading end of AV 100). Example of sensors 121 are a Global Navigation Satellite System (GNSS) receiver, inertial measurement units (IMU) that measure both vehicle linear accelerations and angular rates, wheel speed sensors for measuring or estimating wheel slip ratios, wheel brake pressure or braking torque sensors, engine torque or wheel torque sensors, and steering angle and angular rate sensors.

In an embodiment, the sensors 121 also include sensors for sensing or measuring properties of the AV's environment. For example, monocular or stereo video cameras 122 in the visible light, infrared or thermal (or both) spectra, LiDAR 123, RADAR, ultrasonic sensors, time-of-flight (TOF) depth sensors, speed sensors, temperature sensors, humidity sensors, and precipitation sensors.

In an embodiment, the AV system 120 includes a data storage unit 142 and memory 144 for storing machine instructions associated with computer processors 146 or data collected by sensors 121. In an embodiment, the data storage unit 142 is similar to the ROM 308 or storage device 310 described below in relation to FIG. 3. In an embodiment, memory 144 is similar to the main memory 306 described below. In an embodiment, the data storage unit 142 and memory 144 store historical, real-time, and/or predictive information about the environment 190. In an embodiment, the stored information includes maps, driving performance, traffic congestion updates or weather conditions. In an embodiment, data relating to the environment 190 is transmitted to the AV 100 via a communications channel from a remotely located database 134.

In an embodiment, the AV system 120 includes communications devices 140 for communicating measured or inferred properties of other vehicles' states and conditions, such as positions, linear and angular velocities, linear and angular accelerations, and linear and angular headings to the AV 100. These devices include Vehicle-to-Vehicle (V2V) and Vehicle-to-Infrastructure (V2I) communication devices and devices for wireless communications over point-to-point or ad hoc networks or both. In an embodiment, the communications devices 140 communicate across the electromagnetic spectrum (including radio and optical communications) or other media (e.g., air and acoustic media). A combination of Vehicle-to-Vehicle (V2V) Vehicle-to-Infrastructure (V2I) communication (and, in some embodiments, one or more other types of communication) is sometimes referred to as Vehicle-to-Everything (V2X) communication. V2X communication typically conforms to one or more communications standards for communication with, between, and among autonomous vehicles.

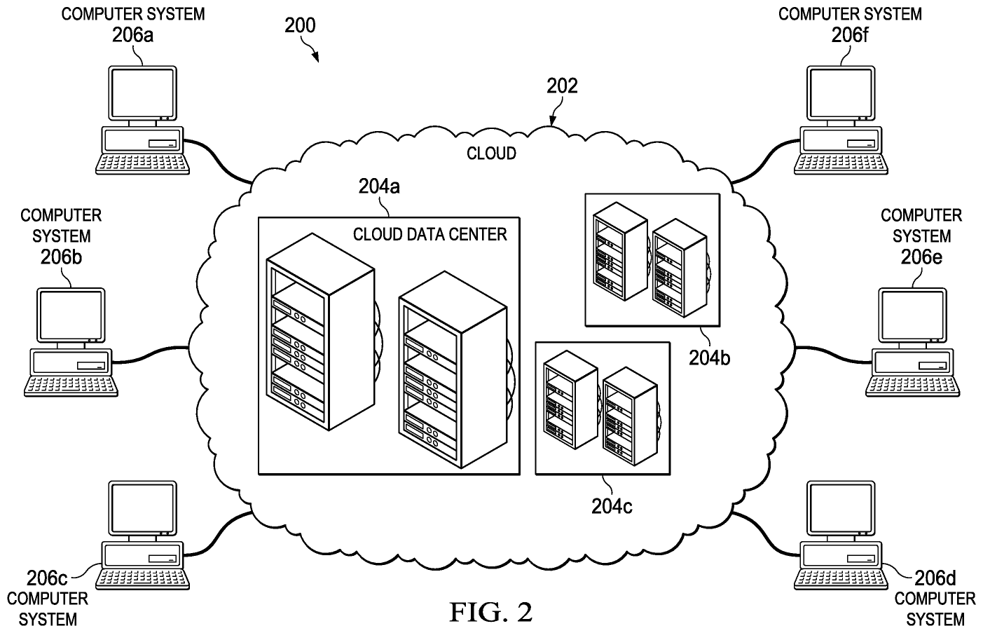

In an embodiment, the communication devices 140 include communication interfaces. For example, wired, wireless, WiMAX, Wi-Fi, Bluetooth, satellite, cellular, optical, near field, infrared, or radio interfaces. The communication interfaces transmit data from a remotely located database 134 to AV system 120. In an embodiment, the remotely located database 134 is embedded in a cloud computing environment 200 as described in FIG. 2. The communication interfaces 140 transmit data collected from sensors 121 or other data related to the operation of AV 100 to the remotely located database 134. In an embodiment, communication interfaces 140 transmit information that relates to teleoperations to the AV 100. In some embodiments, the AV 100 communicates with other remote (e.g., “cloud) servers 136.

In an embodiment, the remotely located database 134 also stores and transmits digital data (e.g., storing data such as road and street locations). Such data is stored on the memory 144 on the AV 100, or transmitted to the AV 100 via a communications channel from the remotely located database 134.

In an embodiment, the remotely located database 134 stores and transmits historical information about driving properties (e.g., speed and acceleration profiles) of vehicles that have previously traveled along trajectory 198 at similar times of day. In one implementation, such data may be stored on the memory 144 on the AV 100, or transmitted to the AV 100 via a communications channel from the remotely located database 134.

Computing devices 146 located on the AV 100 algorithmically generate control actions based on both real-time sensor data and prior information, allowing the AV system 120 to execute its autonomous driving capabilities.

In an embodiment, the AV system 120 includes computer peripherals 132 coupled to computing devices 146 for providing information and alerts to, and receiving input from, a user (e.g., an occupant or a remote user) of the AV 100. In an embodiment, peripherals 132 are similar to the display 312, input device 314, and cursor controller 316 discussed below in reference to FIG. 3. The coupling is wireless or wired. Any two or more of the interface devices may be integrated into a single device.

### Example Cloud Computing Environment

FIG. 2 illustrates an example “cloud” computing environment. Cloud computing is a model of service delivery for enabling convenient, on-demand network access to a shared pool of configurable computing resources (e.g. networks, network bandwidth, servers, processing, memory, storage, applications, virtual machines, and services). In typical cloud computing systems, one or more large cloud data centers house the machines used to deliver the services provided by the cloud. Referring now to FIG. 2, the cloud computing environment 200 includes cloud data centers 204a, 204b, and 204c that are interconnected through the cloud 202. Data centers 204a, 204b, and 204c provide cloud computing services to computer systems 206a, 206b, 206c, 206d, 206e, and 206f connected to cloud 202.

The cloud computing environment 200 includes one or more cloud data centers. In general, a cloud data center, for example the cloud data center 204a shown in FIG. 2, refers to the physical arrangement of servers that make up a cloud, for example the cloud 202 shown in FIG. 2, or a particular portion of a cloud. For example, servers are physically arranged in the cloud datacenter into rooms, groups, rows, and racks. A cloud datacenter has one or more zones, which include one or more rooms of servers. Each room has one or more rows of servers, and each row includes one or more racks. Each rack includes one or more individual server nodes. In some implementation, servers in zones, rooms, racks, and/or rows are arranged into groups based on physical infrastructure requirements of the datacenter facility, which include power, energy, thermal, heat, and/or other requirements. In an embodiment, the server nodes are similar to the computer system described in FIG. 3. The data center 204a has many computing systems distributed through many racks.

The cloud 202 includes cloud data centers 204a, 204b, and 204c along with the network and networking resources (for example, networking equipment, nodes, routers, switches, and networking cables) that interconnect the cloud data centers 204a, 204b, and 204c and help facilitate the computing systems' 206a-f access to cloud computing services. In an embodiment, the network represents any combination of one or more local networks, wide area networks, or internetworks coupled using wired or wireless links deployed using terrestrial or satellite connections. Data exchanged over the network, is transferred using any number of network layer protocols, such as Internet Protocol (IP), Multiprotocol Label Switching (MPLS), Asynchronous Transfer Mode (ATM), Frame Relay, etc. Furthermore, in embodiments where the network represents a combination of multiple sub-networks, different network layer protocols are used at each of the underlying sub-networks. In some embodiments, the network represents one or more interconnected internetworks, such as the public Internet.

The computing systems 206a-f or cloud computing services consumers are connected to the cloud 202 through network links and network adapters. In an embodiment, the computing systems 206a-f are implemented as various computing devices, for example servers, desktops, laptops, tablet, smartphones, Internet of Things (IoT) devices, autonomous vehicles (including, cars, drones, shuttles, trains, buses, etc.) and consumer electronics. In an embodiment, the computing systems 206a-f are implemented in or as a part of other systems.

### Computer System

FIG. 3 illustrates a computer system 300. In an implementation, the computer system 300 is a special purpose computing device. The special-purpose computing device is hard-wired to perform the techniques or includes digital electronic devices such as one or more application-specific integrated circuits (ASICs) or field programmable gate arrays (FPGAs) that are persistently programmed to perform the techniques or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. In various embodiments, the special-purpose computing devices are desktop computer systems, portable computer systems, handheld devices, network devices or any other device that incorporates hard-wired and/or program logic to implement the techniques.

In an embodiment, the computer system 300 includes a bus 302 or other communication mechanism for communicating information, and a hardware processor 304 coupled with a bus 302 for processing information. The hardware processor 304 is, for example, a general-purpose microprocessor. The computer system 300 also includes a main memory 306, such as a random-access memory (RAM) or other dynamic storage device, coupled to the bus 302 for storing information and instructions to be executed by processor 304. In one implementation, the main memory 306 is used for storing temporary variables or other intermediate information during execution of instructions to be executed by the processor 304. Such instructions, when stored in non-transitory storage media accessible to the processor 304, render the computer system 300 into a special-purpose machine that is customized to perform the operations specified in the instructions.

In an embodiment, the computer system 300 further includes a read only memory (ROM) 308 or other static storage device coupled to the bus 302 for storing static information and instructions for the processor 304. A storage device 310, such as a magnetic disk, optical disk, solid-state drive, or three-dimensional cross point memory is provided and coupled to the bus 302 for storing information and instructions.

In an embodiment, the computer system 300 is coupled via the bus 302 to a display 312, such as a cathode ray tube (CRT), a liquid crystal display (LCD), plasma display, light emitting diode (LED) display, or an organic light emitting diode (OLED) display for displaying information to a computer user. An input device 314, including alphanumeric and other keys, is coupled to bus 302 for communicating information and command selections to the processor 304. Another type of user input device is a cursor controller 316, such as a mouse, a trackball, a touch-enabled display, or cursor direction keys for communicating direction information and command selections to the processor 304 and for controlling cursor movement on the display 312. This input device typically has two degrees of freedom in two axes, a first axis (e.g., x-axis) and a second axis (e.g., y-axis), that allows the device to specify positions in a plane.

According to one embodiment, the techniques herein are performed by the computer system 300 in response to the processor 304 executing one or more sequences of one or more instructions contained in the main memory 306. Such instructions are read into the main memory 306 from another storage medium, such as the storage device 310. Execution of the sequences of instructions contained in the main memory 306 causes the processor 304 to perform the process steps described herein. In alternative embodiments, hard-wired circuitry is used in place of or in combination with software instructions.

The term “storage media” as used herein refers to any non-transitory media that store data and/or instructions that cause a machine to operate in a specific fashion. Such storage media includes non-volatile media and/or volatile media. Non-volatile media includes, for example, optical disks, magnetic disks, solid-state drives, or three-dimensional cross point memory, such as the storage device 310. Volatile media includes dynamic memory, such as the main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NV-RAM, or any other memory chip or cartridge.

Storage media is distinct from but may be used in conjunction with transmission media. Transmission media participates in transferring information between storage media. For example, transmission media includes coaxial cables, copper wire and fiber optics, including the wires that include the bus 302. Transmission media can also take the form of acoustic or light waves, such as those generated during radio-wave and infrared data communications.

In an embodiment, various forms of media are involved in carrying one or more sequences of one or more instructions to the processor 304 for execution. For example, the instructions are initially carried on a magnetic disk or solid-state drive of a remote computer. The remote computer loads the instructions into its dynamic memory and send the instructions over a telephone line using a modem. A modem local to the computer system 300 receives the data on the telephone line and use an infrared transmitter to convert the data to an infrared signal. An infrared detector receives the data carried in the infrared signal and appropriate circuitry places the data on the bus 302. The bus 302 carries the data to the main memory 306, from which processor 304 retrieves and executes the instructions. The instructions received by the main memory 306 may optionally be stored on the storage device 310 either before or after execution by processor 304.

The computer system 300 also includes a communication interface 318 coupled to the bus 302. The communication interface 318 provides a two-way data communication coupling to a network link 320 that is connected to a local network 322. For example, the communication interface 318 is an integrated service digital network (ISDN) card, cable modem, satellite modem, or a modem to provide a data communication connection to a corresponding type of telephone line. As another example, the communication interface 318 is a local area network (LAN) card to provide a data communication connection to a compatible LAN. In some implementations, wireless links are also implemented. In any such implementation, the communication interface 318 sends and receives electrical, electromagnetic, or optical signals that carry digital data streams representing various types of information.

The network link 320 typically provides data communication through one or more networks to other data devices. For example, the network link 320 provides a connection through the local network 322 to a host computer 324 or to a cloud data center or equipment operated by an Internet Service Provider (ISP) 326. The ISP 326 in turn provides data communication services through the world-wide packet data communication network now commonly referred to as the “Internet” 328. The local network 322 and Internet 328 both use electrical, electromagnetic, or optical signals that carry digital data streams. The signals through the various networks and the signals on the network link 320 and through the communication interface 318, which carry the digital data to and from the computer system 300, are example forms of transmission media. In an embodiment, the network 320 contains the cloud 202 or a part of the cloud 202 described above.

The computer system 300 sends messages and receives data, including program code, through the network(s), the network link 320, and the communication interface 318. In an embodiment, the computer system 300 receives code for processing. The received code is executed by the processor 304 as it is received, and/or stored in storage device 310, or other non-volatile storage for later execution.

### Autonomous Vehicle Architecture

FIG. 4 shows an example architecture 400 for an autonomous vehicle (e.g., the AV 100 shown in FIG. 1). The architecture 400 includes a perception module 402 (sometimes referred to as a perception circuit), a planning module 404 (sometimes referred to as a planning circuit), a control module 406 (sometimes referred to as a control circuit), a localization module 408 (sometimes referred to as a localization circuit), and a database module 410 (sometimes referred to as a database circuit). Each module plays a role in the operation of the AV 100. Together, the modules 402, 404, 406, 408, and 410 may be part of the AV system 120 shown in FIG. 1. In some embodiments, any of the modules 402, 404, 406, 408, and 410 is a combination of computer software (e.g., executable code stored on a computer-readable medium) and computer hardware (e.g., one or more microprocessors, microcontrollers, application-specific integrated circuits [ASICs]), hardware memory devices, other types of integrated circuits, other types of computer hardware, or a combination of any or all of these things).

In use, the planning module 404 receives data representing a destination 412 and determines data representing a trajectory 414 (sometimes referred to as a route) that can be traveled by the AV 100 to reach (e.g., arrive at) the destination 412. In order for the planning module 404 to determine the data representing the trajectory 414, the planning module 404 receives data from the perception module 402, the localization module 408, and the database module 410.

The perception module 402 identifies nearby physical objects using one or more sensors 121, e.g., as also shown in FIG. 1. The objects are classified (e.g., grouped into types such as pedestrian, bicycle, automobile, traffic sign, etc.) and a scene description including the classified objects 416 is provided to the planning module 404.

The planning module 404 also receives data representing the AV position 418 from the localization module 408. The localization module 408 determines the AV position by using data from the sensors 121 and data from the database module 410 (e.g., a geographic data) to calculate a position. For example, the localization module 408 uses data from a GNSS receiver and geographic data to calculate a longitude and latitude of the AV. In an embodiment, data used by the localization module 408 includes high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations of them), and maps describing the spatial locations of road features such as crosswalks, traffic signs or other travel signals of various types.

The control module 406 receives the data representing the trajectory 414 and the data representing the AV position 418 and operates the control functions 420a-c (e.g., steering, throttling, braking, ignition) of the AV in a manner that will cause the AV 100 to travel the trajectory 414 to the destination 412. For example, if the trajectory 414 includes a left turn, the control module 406 will operate the control functions 420a-c in a manner such that the steering angle of the steering function will cause the AV 100 to turn left and the throttling and braking will cause the AV 100 to pause and wait for passing pedestrians or vehicles before the turn is made.

### Trajectory Generation Using Road Network Model

FIGS. 5A-5C illustrates trajectory templates 500, 501, 502, for various traffic scenarios, in accordance with one or more embodiments. FIG. 5A shows vehicle trajectory templates through an intersection that includes multiple lane changes 500-1, U-turns 500-2 (where the turning radius of the AV is sufficient to make the U-turn while staying in drivable areas) and a left turn 500-3. FIG. 5B shows a vehicle trajectory 501-1 joining and following the only available lane. FIG. 5C shows two agent trajectory templates in a dead-end situation, one trajectory template 502-1 moving forward until the vehicle must stop, the other trajectory template 502-2 making a U-turn despite there being no lane connector to follow.

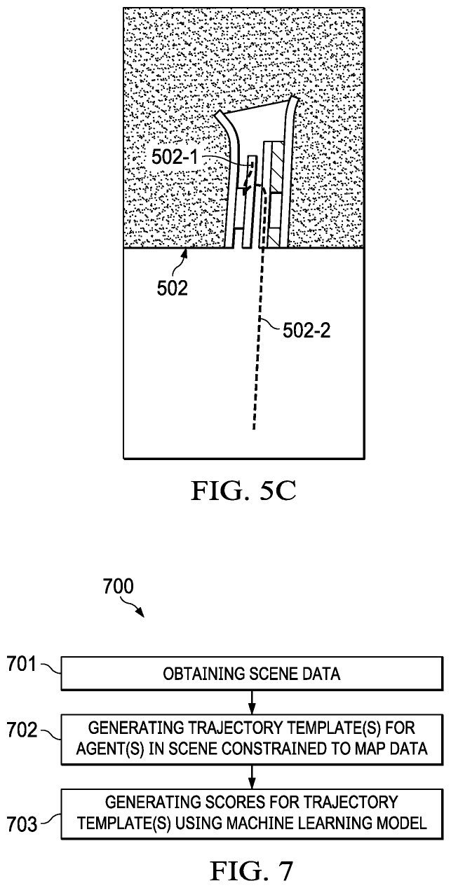

The trajectory templates shown in FIGS. 5A-5C were generated using trajectory template generation system 600 shown in FIG. 6. As described below, system 600 takes as input road map data representing a road network and a start pose (e.g., initial position, velocity and heading) for one or more agents, and generates trajectory templates for the one or more agents. In an embodiment, each trajectory template is represented as a time series of points, where each point is a position coordinate (x, y) in a world reference frame. In other embodiments, other representations are possible, such as generating sequences of lane and connector identifiers before converting into as times series of data points.

Each trajectory template begins at the agent start pose and the motion of the agent is simulated for a specified time (e.g., 6 seconds), so that the agent (e.g., a vehicle) merges into a lane or lane connector of the road network and then follows the lanes and connectors of the road network. In an embodiment, successive points in each trajectory template are separated by distances (e.g., Euclidean distances) equal to step sizes provided by a user, and the total number of points in each trajectory template is the number of step sizes. In an embodiment, the first point of each trajectory template is the first step size away from the initial position, except for trajectory template that dead-end inside the road network, which may not have a full number of requested points.

Given the initial pose of an agent, a trajectory template generator searches the road map data for lanes and connectors of the road network that are within a fixed radius of the initial position of the AV (e.g., 30 m radius). Each lane or connector in the search results is discretized (e.g., with a default spacing of 20 m), and Dubins curves are drawn from the initial position of the agent to a position on the lane or connector. The shortest k Dubins curves (e.g., k=1 as a default) are selected for output. The selected Dubins curves are extended by following the lanes and connectors of the road network using a back-tracking search that is bounded by a specified desired trajectory length (e.g., 6 seconds). In an embodiment, Dubins curves are used to fill in trajectory proposals which occur when the road network leads to a dead end and also at the start of each trajectory to get to a lane. In other embodiments, other parametric families can be used, such as Reeds-Shepp curves or Balkcom-Mason curves.

When generating a trajectory template, it is possible to get stuck during the search (e.g. stuck at the end of a lane with no following connector). If that happens the trajectory template generator attempts to draw the trajectory again by searching for all lanes and connectors within the search radius of the end position of the given trajectory, discretizing the lanes and connectors in the search results, and drawing Dubins curves from the end position to the position on the lane or connector. If the search fails (in which case a shorter than requested trajectory may be returned). Trajectory template generation is concluded by discretizing each sequence of Dubins curves found by the backtracking search, selecting from each a sequence of points separated (in arc length) by the requested step size. Because the road network search process can return multiple Dubins curves that are close together the resulting discrete paths are pruned of duplicates, for example, trajectory templates that are very close at every point are discarded.

In an embodiment, the processes described above can find trajectory templates to all lanes in most intersections of the road network, even when some lane connectors are missing from the road network because the trajectory template generator system 600 fills in a Dubins curve to each lane. The trajectory template generator also generates lane changes on multi-lane roads within a bounded distance, depending on the lengths of lanes and connectors near the start position. On two-way roads with sufficient space between the lanes, the trajectory generation system 600 generates U-turns.

One intended application of the road network trajectory generation described above is to produce predictions of vehicle trajectories. In an embodiment, two sets of trajectories are generated by the trajectory generator that follow the road network: one set having constant speed and the other set having constant acceleration. In an embodiment, appropriate values of speed and acceleration are taken from the agent's track record and the agent's the agent's initial pose (e.g., a state vector including initial position, velocity, heading). The final trajectory template is the union of these two sets of trajectory templates for which the average displacement error with respect to a ground truth trajectory is used as a prediction.

FIG. 6 is a block diagram of a trajectory template generation system 600 for generating trajectory templates, in accordance with one or more embodiments. System 600 includes trajectory template generator 601 that takes as input the current AV location, road map data 608 for the AV location, agent data 609 (e.g., agent type, start pose) and sensor data 610 (e.g., camera images, LiDAR point cloud) captured at the current AV location. In an embodiment, system 600 provides a user interface, such as a graphical user interface (GUI), for allowing a user to manage the trajectory template generation system 600, including but not limited to selecting a traffic scenario, selecting a number and types of agent and setting various parameters (e.g., step size, initial start poses for agents), as described in reference to FIGS. 5A-5C.

Trajectory template generator 601 generates a number of trajectory templates for a particular agent for a particular traffic scenario using road map data. For each agent, the road map data is used to generate a set of possible trajectory templates for the agent for a given traffic scenario, where the trajectory templates are constrained to conform to the lanes and travel directions from the road map data, and to applicable limits imposed by laws of physics (e.g., speed, acceleration, braking and turning constraints). Additionally, each set of trajectory templates for a particular agent include all possible intended behaviors of the particular agent based on the map geometry. For example, when approaching a “T” intersection from the stem of the “T”, generate a left turn, a right turn, and, depending on the speed of the vehicle, a “U” turn. But if the street at the top of the “T” is one-way, generate only the appropriate turn. When between intersections on a 3 lane one-way street, generate three trajectories: two lane changes and one that stays in lane.

Each trajectory template for an agent is provided to spatial attention combiner 604, where the trajectory template is combined with a feature map. The feature map is an image with one feature vector per pixel encoding spatial variation in sensor data at the current AV location. The feature map is output by two-dimensional (2D) convolutional neural network (CNN) 603 in response to receiving an input image. The input image is generated by rasterizer 602 that converts sensor data 610 capturing a scene (e.g., camera images, LiDAR point cloud) into an input image, such as a bird's eye view (BEV) image. Spatial attention combiner 604 generates a local feature vector using an attention mechanism, and the local feature vector is provided as an input into vector combiner 605. Vector combiner 605 combines the local feature vector with a global feature vector (summarizing the entire scene) output by CNN 603 and the scene data (e.g., locations and sensor data for other agents in the scene).

Note that the feature map combined with the trajectory template by the attention mechanism is derived not just from the sensor data, but from all of the scene data, including the road map data. In particular, the BEV image input to the CNN 603 contains not just sensor data but also a representation of the driveable road area and of the lanes, both obtained from the road map data. The local feature vector is concatenated with the global feature vector, and also with a vector of coordinates of the trajectory template, and a short vector containing estimates of the current kinematic state of the agent (e.g., speed, acceleration, yaw rate) obtained from the sensor data to form the output of 605 which is provided as input to 606.

The output of vector combiner 605 is input into score prediction neural network (NN) 606, which predicts a score for the trajectory template. Score NN 606 is a “fully-connected head” (i.e., a multilayer perceptron) and comprises a stack of several fully-connected layers. The input to score NN 606 is the output vector provided by 605. The final output from the last layer of the score NN 606 is one number for each input vector, which combines a trajectory template, its associated local feature vector summarizing its local scene, its associated global feature vector summarizing its entire scene, and its associated agent kinematic state estimates. The entire model, including score NN 606, is trained on datasets where the true future trajectories are known, so as to try to get the scores to be high for predicted trajectory templates that are close to the true future paths and low for the other template trajectories.

Score converter 611 collects all trajectory templates corresponding to a single agent in a single scene, representing of the possible future motions for that agent which were considered by the model. It combines them all into a set of probabilities for these future paths, so that higher score paths get higher probabilities and the sum of the probabilities for a single agent is one. In an embodiment, a softmax operation is used to perform the transformation from scores for one agent to probabilities. The estimated probability for a particular trajectory template represents the probability that an agent will follow the particular trajectory template.

A set of trajectory templates can be generated as described above for each agent in a scene (an area represented by scene data), and used to train and evaluate a deep learning model for motion prediction, such as a 2D or three-dimensional (3D) CNN. The trained and evaluated CNN that can be used in real-time by, for example, planning module 404 shown in FIG. 4 to generate a trajectory for an AV through a traffic scenario with the objective to avoid a collision with an agent. For example, planning module 404 can use the estimated probabilities of the trajectory templates to determine which trajectory template is more likely to be taken by a particular agent, and then generate an appropriate trajectory for the AV to avoid collision with the agent.

In an embodiment, trajectory template generation system 600 includes refinement neural network (NN) 607, which takes the feature map and other sensor data as input and outputs refinements to the trajectory template that are not available in the road map data. Some example refinements include but are not limited to: the speeds with which trajectory templates are traversed by agents and lateral displacements of agents from the trajectory template path centerlines to account for obstacles on one side or another of a lane (e.g., to avoid a parked vehicle) or interactions between agents.

In an embodiment, refinement NN 607 is a fully-connected head that's receive the same input as score NN 606 but produces vectors rather than single numbers. In an embodiment, refinement NN 607 performs xy-regression that predicts an agent's position to a specified future time (e.g., 3 seconds). For example, the agent's position can be predicted every tenth of a second, such that 30 x-coordinates and 30 y-coordinates for the agent position are predicted in total. The output of refinement NN 607 is a vector of length 60 containing increments to be added to the x and y coordinates of the trajectory template from the input of refinement NN 607.

In another embodiment, split lateral and longitudinal regression NN's are used to do the refinement. For example, refinement NN 607 can include two separate fully-connected heads each outputting a vector of length 30 in the example above. One head outputs increments to be added to the distances along the input trajectory template between successive positions of the agent, and the other head outputs lateral displacements to that input trajectory (i.e., adjustments to the predicted position to one side of the template or the other). Separate models make it easier to enforce different scales on the two kinds of adjustment.

In yet another embodiment of refinement NN 607, a smaller output vector from the refinement NN(s) is expanded to the required number of increments using a small set of basis functions which comprise a small library of templates for changes to be made to the trajectory templates. For example, a set of 5 or more Chebysheff polynomials can be used to model lateral displacements, so the lateral refinement NN 607 would output a vector of 5 coefficients used to 5 Chebysheff polynomials into a function from which 30 values are use as lateral adjustments.

In an embodiment, system 600 explicitly takes into account interactions between agents, The initial trajectory templates derived from the road map data for different agents and their probabilities can reasonably be assumed to be at least approximately independent (e.g., whether a vehicle wants to turn left in an intersection will likely not depend on where other vehicles are located), but the execution of these trajectory templates will be influenced by the actions of other agents. In an embodiment, the trajectory template generation for different agents may be performed in parallel, and most of the processing of scene data can be shared among all the agents at the scene.

In an embodiment, system 600 generates trajectory templates for pedestrians, and makes no distinctions between types of vehicle (e.g., cars, trucks, bicycles, etc). For example, an alternate trajectory template generation procedure can be used for pedestrians, bicyclists and other agent types. Trajectory template generation for pedestrians includes walkway and crosswalk data which can be obtained from the road map data and/or other data sources. An example assumption for pedestrians is that pedestrians will follow and stay within walkways or crosswalks. An example assumption for bicyclists is that the bicyclist with follow and stay within a bike path. An example assumption for trucks is that the trucks will follow a designated trucking route as described in the road map data that avoid congestive areas, low bridges, etc. An example assumption for buses is that the buses are presumed to follow bus routes and stay within and/or follow designated bus lanes defined in the road map data.

In an embodiment, system 600 allows for “mixing and matching” of trajectory generation techniques. For example, the road maps described above could be augmented (or replaced) by adding (or substituting) trajectory templates from other data sources (e.g., agent tracking data in an AV log), such as different styles of trajectory templates or purely physics-based models (e.g. constant velocity and heading).

### Example Processes

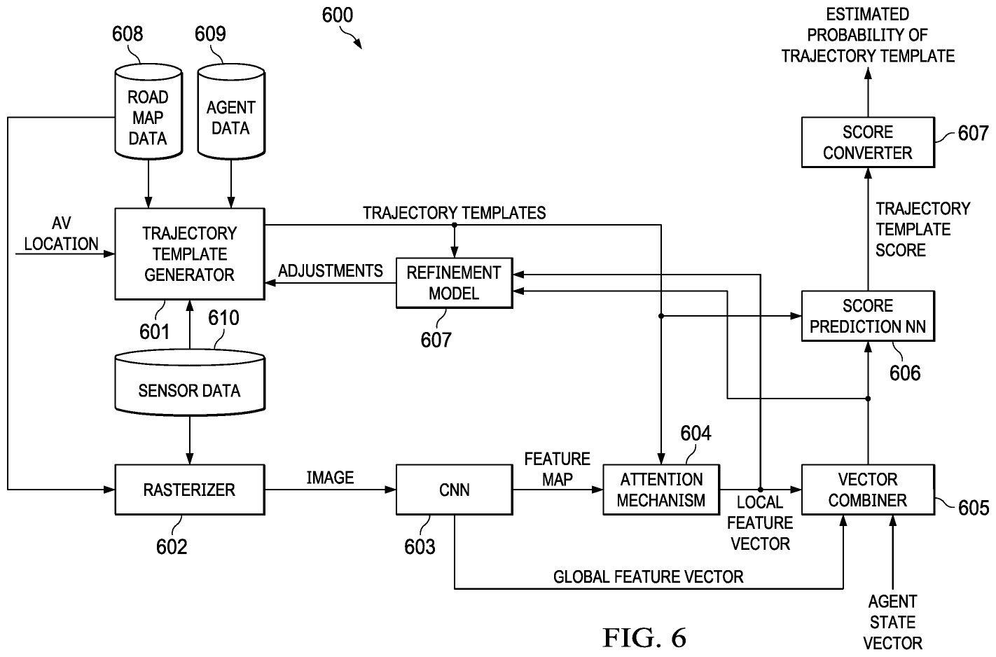

FIG. 7 is a flow diagram of a process 700 for generating trajectory templates for training a deep learning mode for motion prediction, in accordance with one or more embodiments. Process 700 can be implemented using, for example, computer system 300, as described in reference to FIG. 3.

Process 700 can begin by obtaining a location of at least one agent (701), obtaining sensor data collected at the location (702), and obtaining road map data for the location (703).

Process 700 continues by generating at least one possible trajectory template for the at least one agent at the location, wherein the at least one possible trajectory template is constrained in accordance with the road map data (704).

Process 700 continues by predicting, using a machine learning model, a score for the at least one possible trajectory template (705).

In an embodiment, the trajectory template is constrained to a particular lane or connector in the road map data. In an embodiment, process 700 generates an image embedding of the sensor data, processes the image using a convolution neural network to provide a feature map and a global feature vector, generates an attention vector by combining the feature map with the at least one trajectory template using a spatial attention mechanism, generates input data by combining the attention vector, the global feature vector, the sensor data and the location, and inputting the input data into the machine learning model to predict a score for the trajectory template.

In an embodiment, the feature vector and the sensor data are provided as input into a refinement model that outputs adjustments to the at least one trajectory template. Some examples of the adjustments include increasing or decreasing the speed of one or more agents at the location, and laterally displacing one or more agents from a centerline of a road at the location due to, for example, a parked vehicle on the side of the lane.

In the foregoing description, embodiments of the invention have been described with reference to numerous specific details that may vary from implementation to implementation. The description and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further including,” in the foregoing description or following claims, what follows this phrase can be an additional step or entity, or a sub-step/sub-entity of a previously-recited step or entity.

What is claimed is:

1. A method comprising:
obtaining, using at least one processor, scene data, the scene data including a current location of a vehicle, sensor data captured at the location and road map data for the location;
generating, using the at least one processor, at least one possible trajectory template for at least one agent at the location based on the scene data, wherein the at least one possible trajectory template is constrained in accordance with the road map data; and
predicting, using the at least one processor, a score for the at least one possible trajectory template using a machine learning model.

2. The method of claim 1, further comprising:
constraining the trajectory template to a particular lane or connector in the road map data.

3. The method of claim 1, wherein predicting, using a machine learning model, a score for the at least one possible trajectory template further comprises:
generating, an image embedding of the sensor data and the road map data;
processing, using a convolution neural network, the image embedding to provide a feature map and a global feature vector;
generating, using the at least one processor, a local feature vector by combining the feature map with the at least one trajectory template using a spatial attention mechanism;
generating, using the at least one processor, input data by combining the template trajectory position coordinates, the local feature vector, the global feature vector and an agent state vector;
inputting, into the machine learning model, the input data; and
predicting, using the machine learning model, the score for the at least one possible trajectory template.

4. The method of claim 3, wherein the feature map is an image with one feature vector per pixel encoding spatial variation in the sensor data.

5. The method of claim 3, wherein the global feature vector summarizes the sensor data for the location.

6. The method of claim 1, further comprising:
providing the input data to a refinement model that outputs adjustments to the at least one trajectory template.

7. The method of claim 6, wherein the adjustments include increasing or decreasing a speed of one or more agents at the location.

8. The method of claim 6, wherein the adjustments include laterally displacing one or more agents from a centerline of a road at the location.

9. The method of claim 1, wherein the sensor data includes at least one of a camera image or a point cloud from a light detection and ranging (LiDAR) sensor captured at the location.

10. The method of claim 1, wherein the sensor data includes data output by a perception module of the vehicle.

11. The method of claim 1, wherein the at least one agent includes at least one pedestrian and the road map data includes walkway or crosswalk data.

12. The method of claim 1, wherein there are two or more agents and trajectories are generated in parallel based on shared data.

13. The method of claim 1, wherein the at least one trajectory template includes all possible intended behavior of the at least one agent based on the road map data.

14. The method of claim 1, wherein generating, using the at least one processor, the at least one trajectory template for the at least one agent, further comprises:
searching the road map data for lanes and connectors of a road network that are within a fixed radius of the location;
discretizing each lane or connector found in the search using a default spacing; and
for each lane and connector, drawing a path for the at least one agent that begins from a start pose of the at least one agent, merges into the lane or connector and then follows the lane or connector.

15. The method of claim 1, wherein the at least one trajectory template is drawn using Dubins curves.

16. A system comprising:
at least one processor;
memory storing instructions that when executed by the at least one processor, cause the at least one processor to perform operations comprising:
obtaining scene data, the scene data including a current location of a vehicle, sensor data captured at the location and road map data for the location;
generating at least one possible trajectory template for at least one agent at the location based on the scene data, wherein the at least one possible trajectory template is constrained in accordance with the road map data; and
predicting a score for the at least one possible trajectory template using a machine learning model.

17. The system of claim 16, the operations further comprising:
constraining the trajectory template to a particular lane or connector in the road map data.

18. The system of claim 16, wherein predicting, using a machine learning model, a score for the at least one possible trajectory template further comprises:
generating, an image embedding of the sensor data and the road map data;
processing, using a convolution neural network, the image embedding to provide a feature map and a global feature vector;
generating, using the at least one processor, a local feature vector by combining the feature map with the at least one trajectory template using a spatial attention mechanism;
generating, using the at least one processor, input data by combining the template trajectory position coordinates, the local feature vector, the global feature vector and an agent state vector;
inputting, into the machine learning model, the input data; and
predicting, using the machine learning model, the score for the at least one possible trajectory template.

19. The system of claim 16, the operations further comprising:
providing the input data to a refinement model that outputs adjustments to the at least one trajectory template.

20. The system of claim 16, wherein generating, using the at least one processor, the at least one trajectory template for the at least one agent, further comprises:
searching the road map data for lanes and connectors of a road network that are within a fixed radius of the location;
discretizing each lane or connector found in the search using a default spacing; and
for each lane and connector, drawing a path for the at least one agent that begins from a start pose of the at least one agent, merges into the lane or connector and then follows the lane or connector.
